(19) United States
(12) Patent Application Publication
(10) Pub. No.: US 2007/0233618 A1
(43) Pub. Date: Oct. 4, 2007

(54) COMPUTER READABLE RECORDING MEDIUM HAVING DESIGN CREATION SUPPORTING PROGRAM STORED THEREON, DESIGN CREATION SUPPORTING APPARATUS AND COMPUTER DATA SIGNAL FOR SUPPORTING DESIGN CREATION

(75) Inventors: Yoshitsugu Hirose, Kanagawa (JP); Kazushi Ozawa, Tokyo (JP)

Correspondence Address: GAUTHIER & CONNORS, LLP, 225 FRANKLIN STREET, SUITE 2300, BOSTON, MA, 02110, US

(73) Assignee: Fuji Xerox Co., Ltd., Tokyo (JP)

(21) Appl. No.: 11/695,214

(22) Filed: Apr. 2, 2007

(30) Foreign Application Priority Data
Apr. 3, 2006 (JP) 2006102488

(51) Int. Cl. G06F 17/00

(52) U.S. Cl. 706/11

(57) ABSTRACT

A user is caused to select an option matching an impression desired for design creation of a document. Impression information associated with the selected option is extracted, and an evaluation value obtained with respect to the impression information that is extracted is stored in association with the extracted impression information in the form of a desired impression information database. The user is caused to select an option matching an impression given by a design of an actual document. Impression information associated with the selected option is extracted, and an evaluation value obtained with respect to the impression information that is extracted is stored in association with the extracted impression information in the form of a user impression information database.

### CROSS-REFERENCE TO RELATED APPLICATIONS

This application is based on and claims priority under 35 USC 119 from Japanese Patent Application No. 2006-102488, filed on Apr. 3, 2006.

### BACKGROUND

1. Technical Field

The present invention relates to a design creation supporting apparatus for supporting design creation, a computer readable recording medium in which a design creation supporting program is recorded, and a data signal for a design creation supporting process.

2. Related Art

Designs of company cooperate marks, goods, reference materials for presentation, website pages, and so on significantly affect the impression given to customers and users, and so on. Thus, in design creation, it is important to appropriately and precisely represent an impression which persons attempting to provide corporate strategies and marketing strategies or provide information wish to make on receivers (users).

When one requests design creation of a product to a design creator, for example, as shown in the flowchart in FIG. 34, a client, who is a requesting person, determines a desired impression required for the product or presentation materials of the product (S100), and the design creator creates a design matching the desired impression (S102). The impression of the created design is then evaluated (S104), and based on a difference between the required impression and the impression of the actual design, the requesting person provides instructions for changing the design, if it is necessary, and otherwise, the design is finally determined (S106).

With regard to such design creation as described above, a large number of software applications have been developed for supporting image rendering and coloring of products or documents such as presentation materials and web pages. In most of these applications, however, actual coloring is left to application users, leading to a problem that users not skilled in design creation would have difficulty in appropriately and precisely representing a desired impression.

In order to deal with the above difficulty, studies and research have been made concerning a method for performing a process and evaluating an impression of a document based on human sensibilities.

### SUMMARY

In accordance with one aspect of the invention, there is provided a computer readable recording medium storing a design creation supporting program causing a computer having a memory that stores an impression expression database including options that express an impression of a document and an impression evaluation database storing impression information that represents an impression of a human at the sight of a document in association with the options included in the impression expression database, to execute the following process for supporting design creation. Specifically, the process includes: causing a user to select and acquire at least one option that matches an impression that is desired for design creation of a document from the impression expression database; causing a user to select and acquire at least one option that matches an impression given by a design of an actual document from the impression expression database; extracting impression information associated with the option selected in the process for causing a user to select and acquire at least one option that matches an impression that is desired for design creation of a document, with reference to the impression evaluation database, and storing an evaluation value obtained with respect to the impression information that is extracted in association with the extracted impression information in the form of a desired impression information database; and extracting impression information associated with the option selected in the process for causing a user to select and acquire at least one option that matches an impression given by a design of an actual document, with reference to the impression evaluation database, and storing an evaluation value obtained with respect to the impression information that is extracted in association with the extracted impression information in the form of a user impression information database.

### BRIEF DESCRIPTION OF THE DRAWINGS

Exemplary embodiments of the present invention will be described in detail based on the following figures, wherein:

FIG. 1 is a block diagram showing an overall structure of a design creation supporting apparatus in accordance with an exemplary embodiment of the present invention;

FIG. 2 is a block diagram showing a structure of a management server in the exemplary embodiment of the present invention;

FIG. 3 is main flowchart of a Design Creation Supporting Method in the exemplary embodiment of the present invention;

FIG. 4 is a view showing a main menu screen in the exemplary embodiment of the present invention;

FIG. 5 is a flowchart of a desired impression determining process in the exemplary embodiment of the present invention;

FIG. 6 is a view showing a desired impression input screen in the exemplary embodiment of the present invention;

FIG. 7 is a view showing an impression expression database in the exemplary embodiment of the present invention;

FIG. 8 is a view showing an impression map in the exemplary embodiment of the present invention;

FIG. 9 is a view showing an impression evaluation database in the exemplary embodiment of the present invention;

FIG. 10 is a view showing a desired impression information database in the exemplary embodiment of the present invention;

FIG. 11 is a view showing an impression evaluation database in the exemplary embodiment of the present invention;

FIG. 12 is a view showing a desired impression information database in the exemplary embodiment of the present invention;

FIG. 13 is a flowchart of a design impression evaluation process in the exemplary embodiment of the present invention;

FIG. 14 is a view showing a design impression evaluation screen in the exemplary embodiment of the present invention;

FIG. 15 is a view showing a design database in the exemplary embodiment of the present invention;

FIG. 16 is a view showing an example web page in the exemplary embodiment of the present invention;

FIG. 17 is a view showing a design evaluation database in the exemplary embodiment of the present invention;

FIG. 18 is a flowchart of a user impression acquiring process in the exemplary embodiment of the present invention;

FIG. 19 is a view showing a document data selection screen in the exemplary embodiment of the present invention;

FIG. 20 is a view showing a user impression input screen in the exemplary embodiment of the present invention;

FIG. 21 is a view showing a user impression information database in the exemplary embodiment of the present invention;

FIG. 22 is a view showing a user impression information database in the exemplary embodiment of the present invention;

FIG. 23 is a flowchart of an impression presentation and correction process in the exemplary embodiment of the present invention;

FIG. 24 is a view showing a display selection screen in the exemplary embodiment of the present invention;

FIG. 25 is a view showing an impression map screen in the exemplary embodiment of the present invention;

FIG. 26 is a view showing an impression map displaying database in the exemplary embodiment of the present invention;

FIG. 27 is a view showing an impression map screen in which desired impression information is displayed in a superposed manner;

FIG. 28 is a view showing an impression map screen in which desired impression information is displayed in a superposed manner;

FIG. 29 is a view showing an impression map screen in which design impression information and document data is displayed in a superposed manner;

FIG. 30 is a view showing an impression map screen in which user impression information is displayed in a superposed manner;

FIG. 31 is a view showing an impression map screen in which desired impression information, design impression information and document data is displayed in a superposed manner;

FIG. 32 is a view showing an impression map screen displaying information representing a difference between a desired impression and the actual impression;

FIG. 33 is a view showing an impression map screen displaying information representing a difference between a desired impression and the actual impression; and

FIG. 34 is a flowchart of design creation.

### DETAILED DESCRIPTION

Exemplary embodiments of the present invention will be described in detail with reference to the accompanying drawings.

### 1. Structure of Apparatus

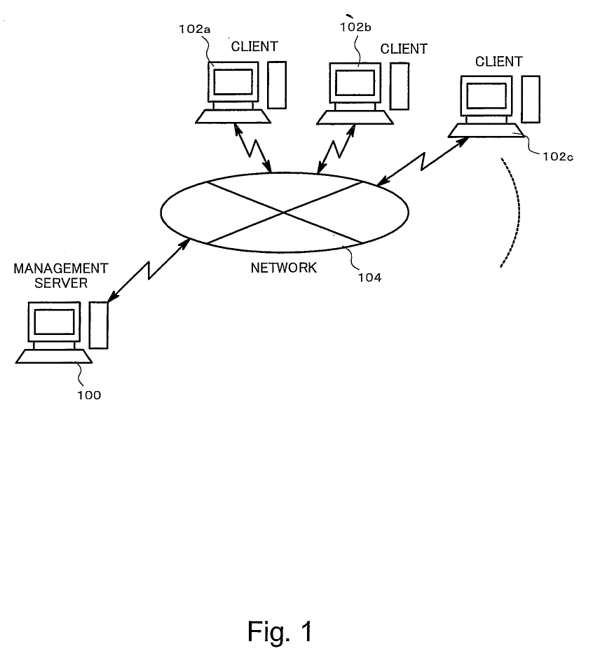

As shown in FIG. 1, a design creation supporting apparatus in one exemplary embodiment of the present invention includes a management server 100, client computers 102a, 102b, . . . , and a network 104. The management server 100 and the client servers 102 are connected with each other via the network 104 so as to allow information communication therebetween.

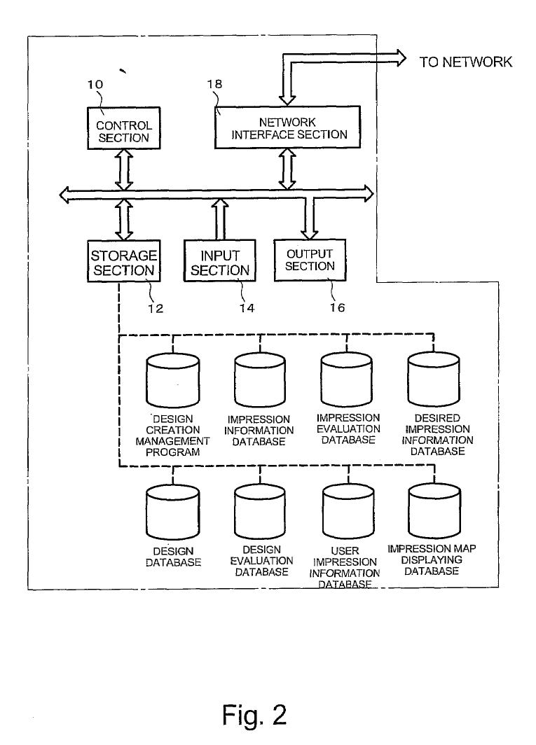

As shown in FIG. 2, the management server 100 is basically composed of a control section 10, a storage section 12, an input section 14, an output section 16, and a network interface section 18.

The control section 10 reads and executes a design creation supporting program stored in the storage section 12. The control section 10 also captures data necessary for the processing through the input section 14 and the network 104, and stores the captured data in the storage section 12. Further, the control section 10 reads and processes necessary data from the storage section 12. In addition, the control section 10 stores the processed result back in the storage section 12 and also outputs the data to the output section 16 or the network 104, as required.

The storage section 12 stores and holds the design creation supporting program and various other data such as key words captured through the input section 14 and the network 104. The storage section 12 also stores and holds various databases necessary for the processing including an impression expression database, an impression evaluation database, a desired impression information database, a design evaluation database, a design database, a user impression information database, an impression map displaying database, and so on. The content and the usage of each of these databases will be described below. While a semiconductor memory is mainly used for the storage section 12, it is also possible to use, as the storage section 12, a memory device such as a hard disk, an optical disk, a magneto-optical disk, and a magnetic tape.

The input section 14 is used by a user for inputting data necessary for processing. As the input section 14, a character input device such as a keyboard, and a pointing device such as a mouse, a light pen, and so on, can be used. Further, when presentation reference materials or the like which are prepared in the form of a recording medium such as paper are electronically read to obtain electronic data thereof, a document reader such as a scanner can be used. In addition, when speech or the like is input, a voice input device which allows conversion of audio data into a digital signal can be used as the input section 14.

The output section 16 displays an input screen that facilitates user's data input necessary for processing, an output screen that displays a processed result supplied from the control section 10, and so on. As the output section 16, a document output device such as a display, a printer, and so on can be used.

The network interface section 18 is used for connecting the management server 100 with the network 104 such that they can communicate information with each other.

The client computers 102a, 102b, . . . also have a basic computer structure similar to that of the management server 100 described above, such that each client server 102 can, via the network 104, transmit information necessary for processing to the management server 100 and also receive the processed results obtained in the management server 100. Also, a portion of the design creation support processing which will be described below may be executed by the client computer 102.

### 2. Design Creation Supporting Method

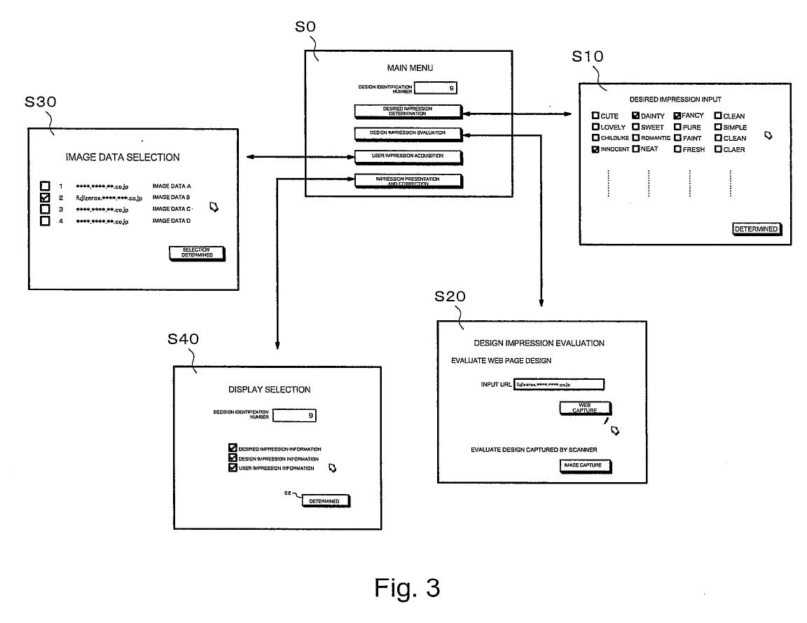

Referring to FIG. 3, a design creation supporting method according to the present exemplary embodiment will be described in detail. It should be noted that each process in the invention according to claims of the present application can be implemented by causing a computer to execute each of the processes of the design creation supporting method as described below.

Hereafter, description will be provided based on the assumption that the system is used by a subject that performs creation of a design (hereinafter referred to as a design creator), a subject that requests design creation to the design creator (hereinafter referred to as a client), and a subject that receives a created design (hereinafter referred to as a user). Further, a task and an operation that can be performed by any one of the design creator, the client, and the user will be generally described as an operation performed by an operator. While the design creator, the client, and the user are normally different subjects, they may be an identical subject in a case where the design creator themselves appropriately changes the design they have created, and so on.

Each of the client computers 102a, 102b, . . . , which is connected via the network 104 with the management serer 100 for communication, can function either as a terminal of the design creator or a terminal of the client. In the following description, for the sake of convenience, it is assumed that an operator uses the management server 100 to perform processing.

As shown in FIG. 3, the design creation supporting method includes a desired impression determination process in step S10, a design impression evaluation process in step S20, a user impression acquisition process in step S30, and an impression presentation and correction process in step S40.

Each of these processes is implemented by executing by the management server 100 a design creation supporting program which can be processed by a computer and which is stored and held in the storage section 12 of the management server 100.

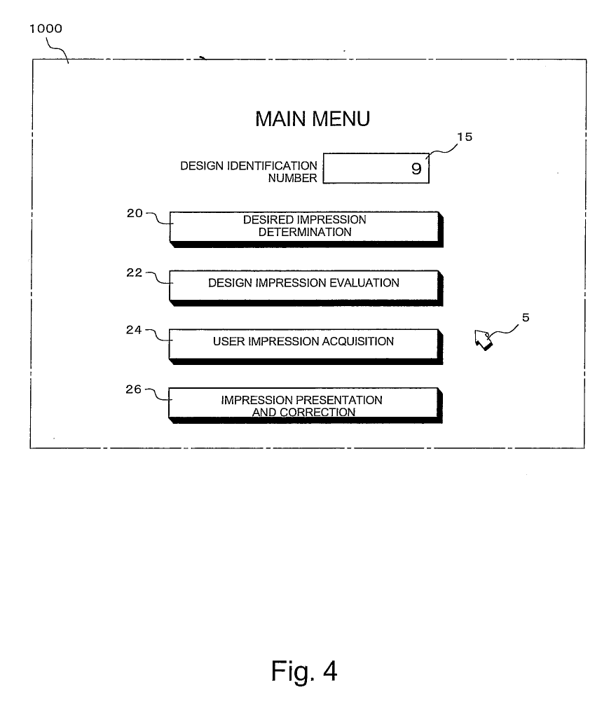

Upon starting the program, in step S0, the control section 10 causes the output section 16 to display a main menu screen 1000 for urging an operator to select a desired processing, as shown in FIG. 4. Here, a mouse pointer 5 is displayed in the main menu screen 1000, and execution of each processing is started upon clicking on the position on the screen corresponding to the desired processing using the mouse pointer 5.

Further, the main menu screen 1000 includes a box 15 in which an identification number of a design to be created is input. In the following processing, the number which is input in this box 15 is used for identifying the databases or the like.

For example, when “9” is input as an identification number in the box 15 and the mouse pointer 5 is moved to the position where the desired impression determination button 20 is displayed and the button 20 is clicked on using the mouse, the design identification number is determined to be “9” and the processing proceeds to the desired impression determination process in step S10. Similarly, the processing can proceed to the design impression evaluation process in step S20, the user impression acquisition process in step S30, the impression presentation and correction process in step S40, by moving the mouse pointer 5 to the corresponding positions on the screen and then clicking the desired button using the mouse.

### 2-1. Desired Impression Determination Process

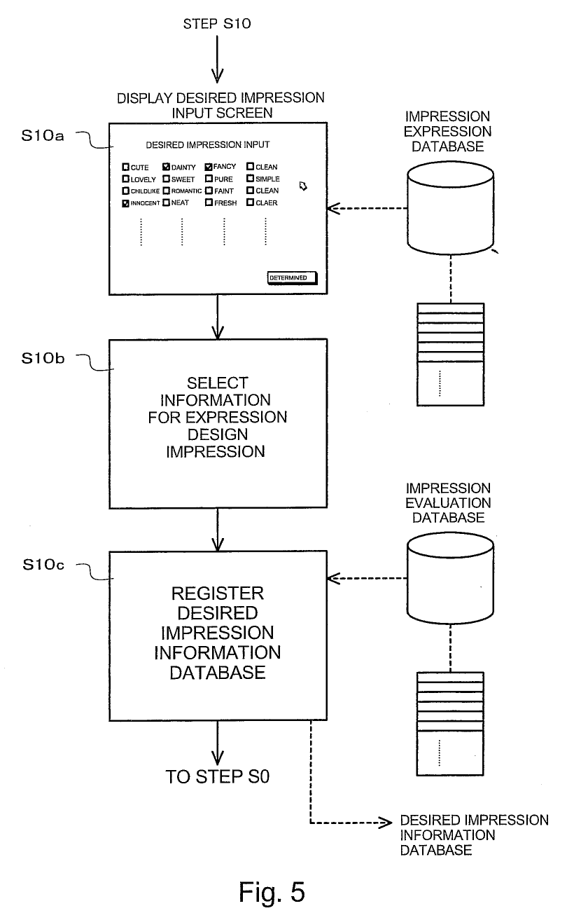

In the desired impression determination process in step S10, information concerning an impression necessary for a design to be created (hereinafter referred to as desired impression information) is determined. This desired impression determination process is performed based on the flowchart shown in FIG. 5.

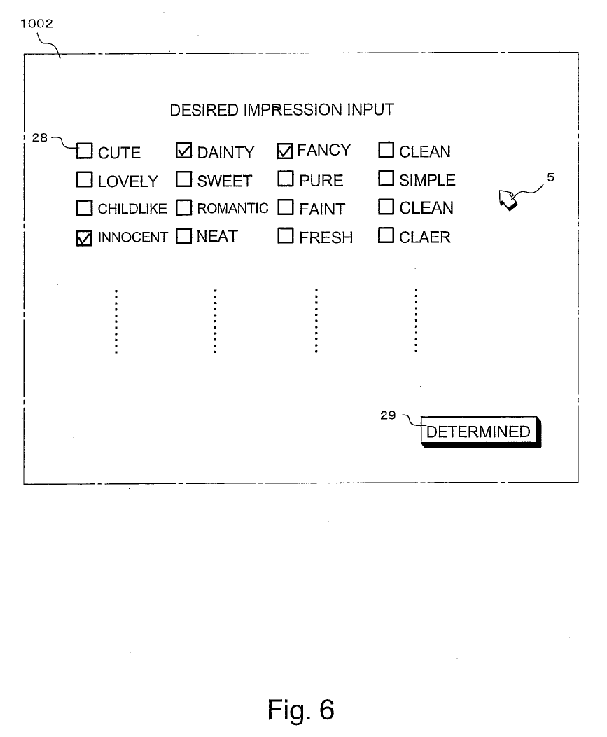

First, in step S10a, the control section 10 causes the output section 16 to display a desired impression input screen 1002. As shown in detail in FIG. 6, the desired impression input screen 1002 displays plural information items which express design impressions, for urging the client to select an information item matching the desired impression for design creation.

Here, it is preferable for the information which expresses the design impression to include character information composed of adjectives which briefly express design impressions, color information composed of color palettes formed of a combination of plural colors, a group of abstract pictures which abstractly express design impressions, and so on, and for an appropriate information item to be selected and used depending on an object of design creation. These information items can be prestored in the form of an impression expression database in the storage section 12, so that they can be read and used as required.

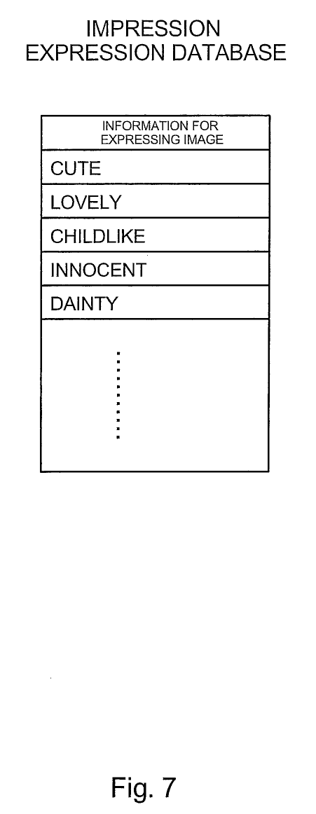

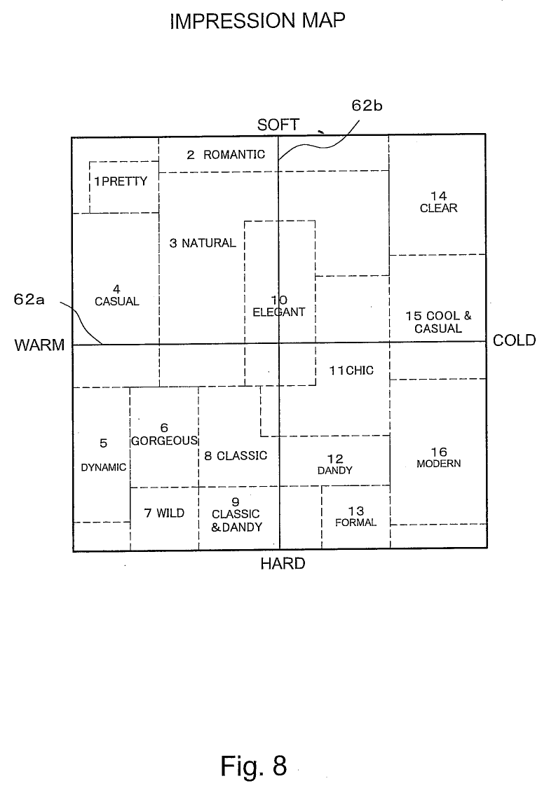

In the present exemplary embodiment, an impression on a document desired by the user is obtained using the impression expression database shown in FIG. 7. The impression expression database includes expressions that are adjectives covering a whole impression map as shown in FIG. 8. Here, an impression map refers to a map having a display screen divided into plural regions, each of which is allocated as a region indicating a document impression. Specifically, coordinate axes are provided in the impression map, and information representing an impression is allocated such that the impression changes with a predetermined tendency along the coordinate axes. In the example shown in FIG. 8, for example, two orthogonal coordinate systems, which are X coordinates indicating the warmth of a design between “warm” and “cool” and Y coordinates indicating the hardness of a design between “soft” and “hard”, are provided, and information representing an impression is allocated in accordance with a change of the impression. The method of allocating information to an impression map is not limited to this example, and it is preferable to modify setting of the coordinate axes in accordance with the type of object design.

In this example, as shown in FIG. 6, the output section 16 is caused to display the desired impression input image 1002 in which adjectives read from the impression expression database are listed and displayed.

In step S10b, the client selects, through the input section 14, information matching an impression required for a design. Here, plural impression expression databases can be provided, so that the user is allowed to select information matching the desired impression using the plural references.

More specifically, the client which requests document creation uses a mouse which serves as the input section 14 to move the mouse pointer 5, which is displayed in a superposed manner on the desired impression input screen 1002, to a check box 28 provided for the adjective matching the impression required for the design. The check box 28 is then clicked using the mouse and selected. Here, the check mark is displayed in the selected check box 28. On completion of selection, the mouse pointer 5 is moved to the position of a determination button 29 and the determination button 29 is clicked using the mouse, whereby the character information concerning the selected adjectives is stored in the storage section 12. In the example of FIG. 6, the character information of “innocent”, “dainty”, and “fancy” is selected and stored in the storage section 12.

Here, the method of selecting information which expresses an impression is not limited to the above example, and any other methods that can facilitate input by the client may also be used.

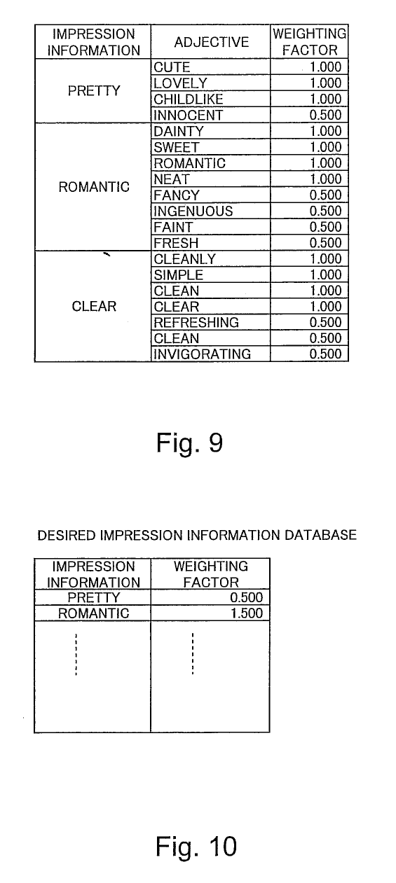

Then, in step S10c, the desired impression information database in the document design creation is registered based on the information selected in step S10b. The impression evaluation database is used for this processing. As shown in FIG. 9, in the impression evaluation database, with regard to each impression information associated with each section indicating an impression on the impression map, information items (adjectives) included in the impression expression database and a weighting factor indicative of a relative degree of significance of each information item (adjective) associated with each impression information with respect to that impression information are associated and stored. A single weighting factor is associated with each information item (adjective).

The control section 10 reads the information (adjectives) selected in step S10b from the storage section 12, and extracts the impression information and corresponding weighting factors associated with the read information (adjectives) by referring to the impression evaluation database shown in FIG. 9. The control section 10 then adds up the weighting factors for each item of impression information that is selected. The control section 10 then stores the extracted impression information and an evaluation value which is a sum of the weighting factors for each impression information in the storage section 12 in the form of the desired impression information database.

For example, if the character information which is selected is “innocent”, the impression information “pretty” is extracted in the example impression evaluation database of FIG. 9, and the weighting factor 0.500 of “innocent” with respect to “pretty” is extracted. Further, if the character information “dainty” is selected, the impression information “romantic” is extracted, and the weighting factor thereof with respect to “romantic”, which is 1.000, is extracted. In addition, if the character information “fancy” is selected, the impression information “romantic” is extracted, and the weighting factor thereof with respect to “romantic”, which is 0.500, is extracted. In this case, as the evaluation value for each impression information, the evaluation value for “pretty” is 0.500, and the evaluation value for “romantic” is 1.500. Consequently, the impression information as shown in FIG. 10 is registered.

While in the above example, the desired impression information database is registered based on information selection by a single client, it is also possible to repeat the above-described processing to calculate the evaluation value for each impression information from the information obtained by plural clients, thereby registering the desired impression information database. For example, plural executives in a single company are caused to select adjectives, and the corresponding impression information is extracted and the evaluation value which is a sum of the corresponding weighting factors is calculated for each extracted impression information. Further, the evaluation values from plural clients are summated for each impression information, and the sum is associated with each impression information, thereby registering the desired impression information database.

It is also preferable to repeat the above processing concerning a single user or users having the same attribute at specified intervals, to thereby register the desired impression information database in consideration of changes with time in the design impression desired by the user. In this case, each and every time the single user or the users having the same attribute repeat the above processing at a specified interval, the evaluation value which is a sum of weighting factors is calculated for each extracted impression information. Then, the evaluation values thus calculated are summated for each impression information, and the sum is associated with each impression information, thereby registering the desired impression information database.

According to the present exemplary embodiment, because the weighting factor associated with each information is set based on the degree of significance of each information with respect to the corresponding impression information, the resulting desired impression information can clearly indicate the tendency of the impression which is desired for design creation.

### <Modification Example>

In the above exemplary embodiment, the weighting factor which is set based on the degree of significance of each information with respect to the corresponding impression information is used for processing. In this modification example, the weighting factor is set such that each impression information is equally evaluated, thereby performing processing.

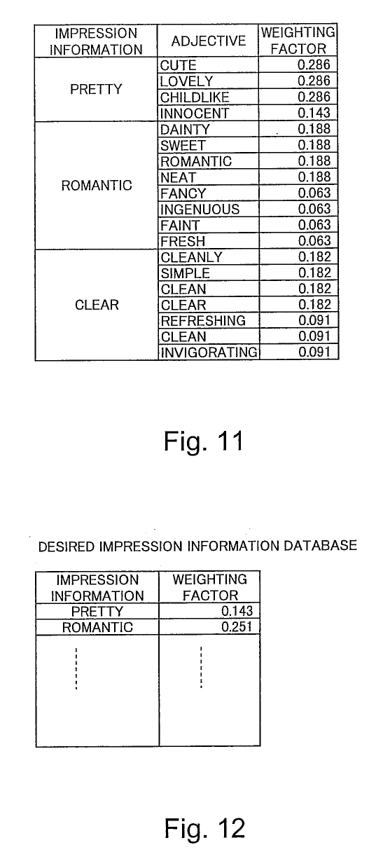

Specifically, in step S10c, the desired impression information database in design creation of a document is registered based on the information selected in step S10b. In this example, however, the impression evaluation database shown in FIG. 11, rather than that shown in FIG. 9, is used for the processing. In this impression evaluation database shown in FIG. 11, the weighting factor of each information item (adjective) is set such that a sum of the weighting factors of the information items (adjectives) associated with each impression information is equal. Here, a single weighting factor is associated with each information item (adjective).

More specifically, the control section 10 reads the information (adjectives) selected in step S10b from the storage section 12, and extracts the impression information and the weighting factors associated with the information (adjectives) thus read by referring to the impression evaluation database shown in FIG. 11. The control section 10 then stores in the storage section 12 the extracted impression information and an evaluation value which is a sum of the weighting factors for each impression information in association with the identification number of a design in the form of a desired impression information database.

For example, if the character information which is selected is “innocent”, the impression information “pretty” is extracted in the example impression evaluation database of FIG. 11, and the weighting factor 0.143 of “innocent” with respect to “pretty” is extracted. Further, if the character information “dainty” is selected, the impression information “romantic” is extracted, and the weighting factor thereof with respect to “romantic”, which is 0.188, is extracted. In addition, if the character information “fancy” is selected, the impression information “romantic” is extracted, and the weighting factor thereof with respect to “romantic”, which is 0.063, is extracted. In this case, as the evaluation value for each impression information, the evaluation value for “pretty” is 0.143, and the evaluation value for “romantic” is 0.251. Consequently, the desired impression information as shown in FIG. 12 is registered.

Here, as described in the above exemplary embodiment, it is also preferable to repeat the above processing to calculate the evaluation value of each impression information from information obtained from plural clients. It is further preferable to repeat the above processing concerning a single user or users having the same attribute at certain intervals, to thereby calculate the evaluation value of each impression information in consideration of changes with time in the design impression desired by the user.

This modification example, in which the weighting factor associated with each information is set such that each impression information is equally evaluated, is suitable for a case where an impression desired for design creation is compared among different impression information or is compared with the evaluation results of other impressions.

Further, it is also possible to prestore both of the impression evaluation databases shown in FIGS. 9 and 11 in the storage section 12, and select either one of these databases as required for reference. For example, it is preferable to cause a user to select either one of these impression evaluation databases for reference in step S10c, and perform processing with reference to the database selected by the user. This allows the user to select whether the user wishes to create a desired impression information database, which clearly indicates the tendency of an impression desired for design creation, or a desired impression information database which allows clear comparison with other impression information.

### 2-2. Design Impression Evaluation Process

When a design impression evaluation button 22 is clicked in step S0, the processing proceeds to a design impression evaluation process in step S20.

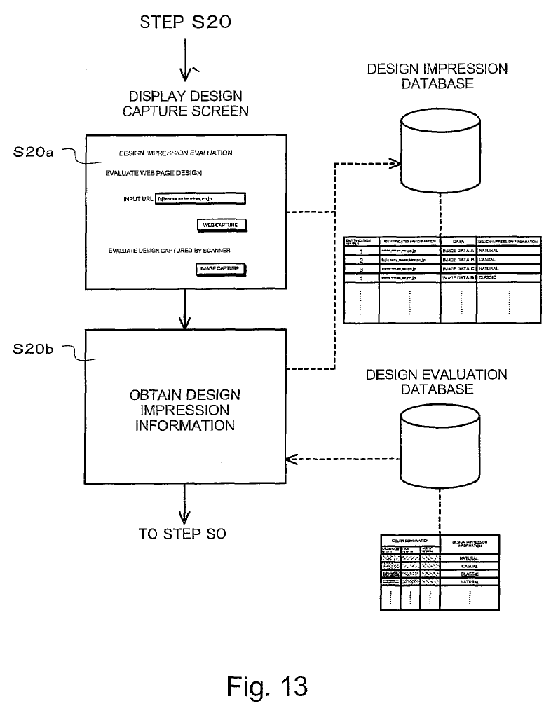

In the design impression evaluation process in step S20, information concerning an impression of a design of a document (hereinafter referred to as design impression information) is extracted. This process is performed in accordance with the flowchart shown in FIG. 13.

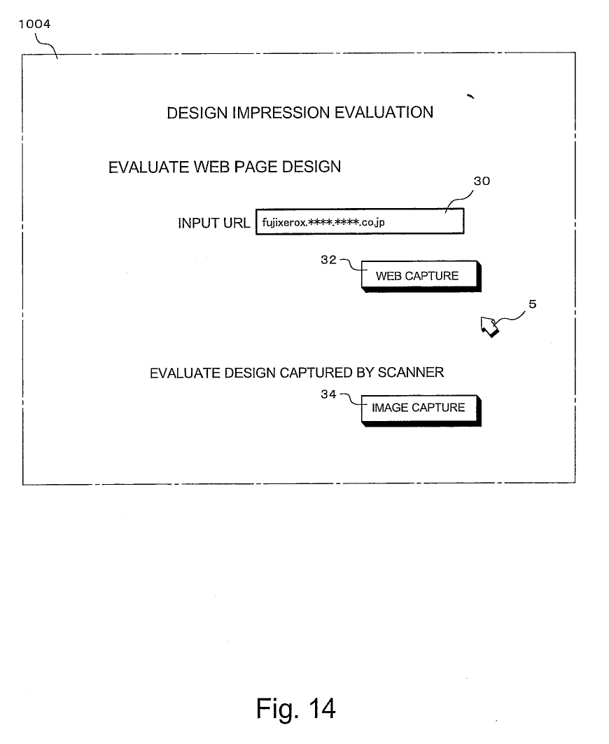

First, in step S20a, actual document data is captured and the captured data is stored and held in the storage section 12. Specifically, the control section 10 displays a design capture screen 1004 on the output section 16, as shown in FIG. 14, for urging a design creator to input a document concerning a design to be evaluated.

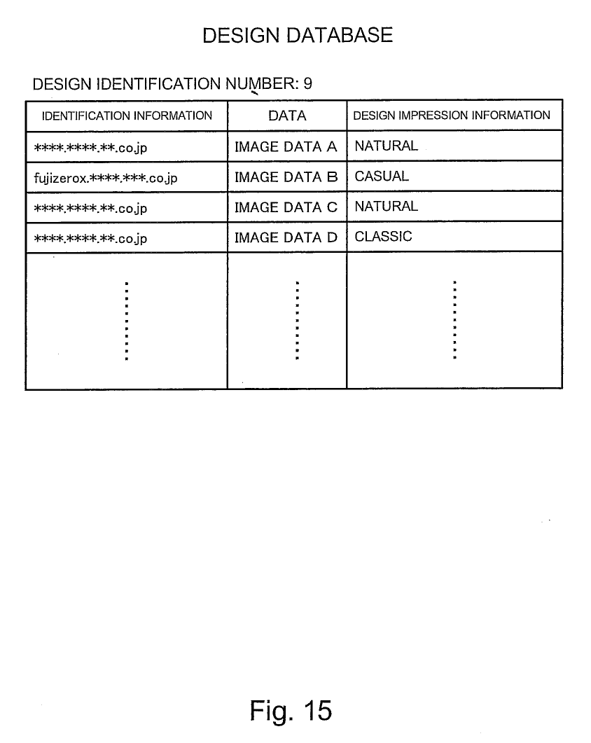

For example, a design creator previously designs a web page and uploads the web page to the network 104. Then, the design creator inputs the URL of the web page in a URL input box 30 on the design capture screen 1004, and moves the mouse pointer 5 displayed on the design capture screen 1004 to a web design capture button 32 which is then clicked using the mouse, thereby designating the destination address of the web page which is an object of design impression evaluation. The control section 10, when receiving designation of an object, captures document data of the web page from the designated URL via the network 104. The document data thus captured is sequentially stored in the storage section 12 in the form of a design database in association with the identification information (e.g. URL) of the document data, as shown in FIG. 15.

Here, if a design database has not been generated for a certain design identification number, a new design database is generated in association with the identification number of the design. On the other hand, if a design database already exists for a certain design identification number, identification information of document data and the document data is additionally stored in the existing design database.

Further, it is also possible to designate not only the URL of a web page created by a design creator but also the URL of a web page of a competing company for capturing and evaluating the document data of the web page.

If the object of design creation is presentation reference material, a brand logo of a new product or a company, or the like, it is preferable to capture document data using a reading device such as a scanner. In this case, it is preferable to configure the system to actuate an existing document reading tool upon clicking on a document capture button 34 on the design capture screen 1004.

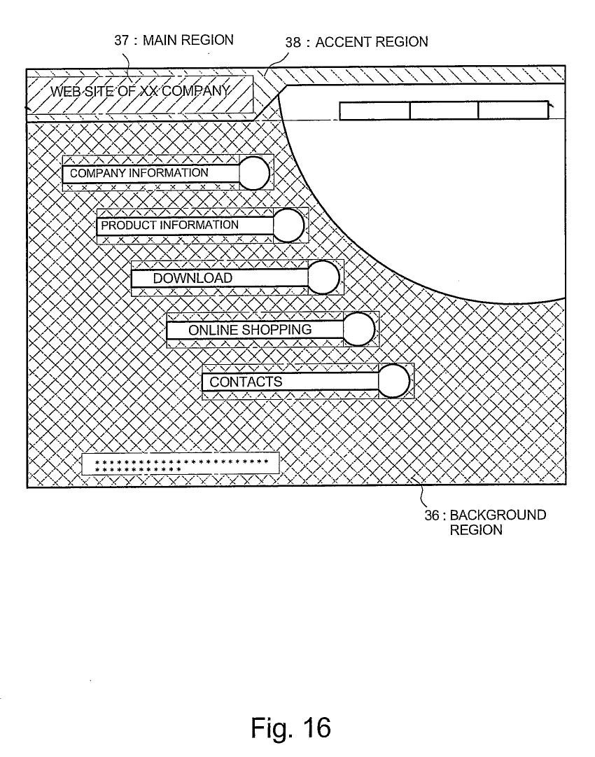

In the following description, it is assumed that an example document which is a web page shown in FIG. 16 has been captured.

In step S20b, evaluation of an impression given to a human by the document data which is captured is performed. For evaluation of the design impression, an existing evaluation means as described in Japanese Patent Application No. 2002-187522 or the like can be used.

Specifically, the control section 10 reads image data of a document to be evaluated from the storage section 12 and divides the image into regions as shown in FIG. 16. For division of regions, an existing image region dividing tool can be used. Then, a physical feature amount, such as the area, the position, the size, the color average, the color difference with respect to other regions, and so on, is extracted for each divided region.

Here, it is preferable to extract the visual feature amount after converting each region from the RGB color space to the L*a*b* color space. In general, as document data which is used by a computer is often expressed in the RGB color space, which is an uneven color space, analysis which is close to human visual sensitivity cannot be applied. By converting the RGB color space, which is an uneven color space, into the L*a*b* color space, which is an even color space, the image can be analyzed and evaluated as an impression in a manner closer to human sensitivity. The L*a*b* color space is also preferable in that it can express the dynamic range of the document. Obviously document data which is already expressed in the L*a*b* color space does not need to be converted.

Further, the physical feature amounts refer to features including the area of a target region, the width w and height h of a target region, the position (x, y) of the upper left portion of a target region, the color average of an entire target region, the average values of L* components, a* components, and b* components, respectively, a color difference ΔL*a*b* between the color average of an entire document and the color average of the entire target region, a color difference ΔL*a*b* between the background and a target region, color distribution and the number of identical colors within a target region, and so on. Further, the feature amounts may also be obtained by extracting the average color from a background region of document data, a main region having the largest area other than the background region, and an accent region which adds an accent to the main region.

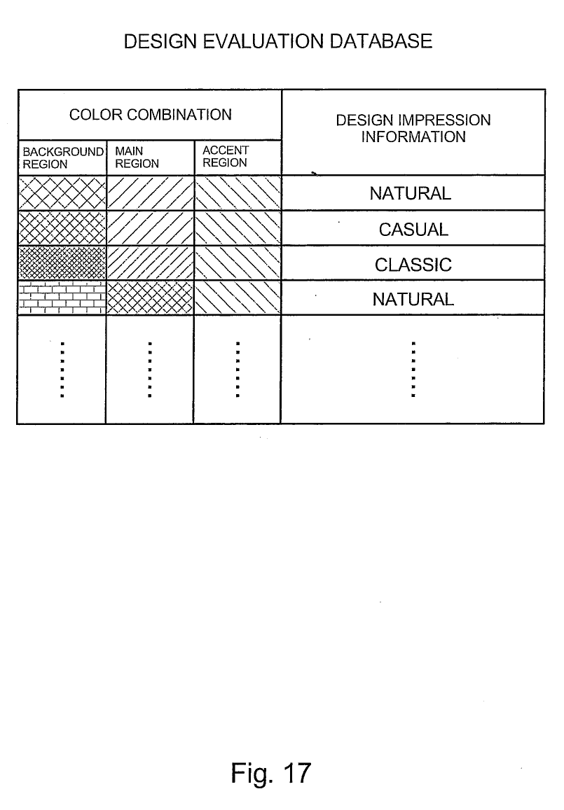

On the other hand, design impression information is associated with a combination of the physical feature amounts, and such data is stored and held in the storage section 12 in the form of a design evaluation database. For example, as shown in FIG. 17, a combination of colors of the background region, the main region having the largest area other than the background region, and the accent region which adds an accent to the main region (shown by hatching in FIG. 17), is generated and then stored in association with design impression information representing an impression given to a human by each combination of colors.

Based on this design evaluation database, it is possible to extract the average colors from the background region, the main region, and the accent region, and extract the design impression information based on the combination of the average colors. The design impression information thus extracted is stored and held in the storage section 12 in association with an identification number of document data and the document data to be evaluated in the form of a design database, as shown in FIG. 15.

For example, when the average color is extracted from the background region, the main region, and the accent region of the document data shown in FIG. 16, the design impression information “natural” can be obtained based on the design evaluation database shown in FIG. 17.

Here, the feature amounts which can be used for extracting information concerning an impression may include the area of a region, the width w and height h of a region, the position (x,

y) of the upper left portion of a region, the color average of an entire region, the average values of L* components, a* components, and b* components, respectively, a color difference ΔL*a*b* between the color average of an entire document and the color average of the entire target region, a color difference ΔL*a*b* between the background and a target region, color distribution and the number of identical colors within a target region, and so on.

Further, a multi-dimensional expression information database in which a condition for a combination of these feature amounts is associated with the expression information concerning a document impression may be used. As such, by combining as many feature amounts as possible, a more detailed impression given by a document to a human can be obtained. In particular, with the use of the condition including a difference in the feature amounts between different document regions, such as a color difference between different document regions, the expression information representing an impression given by a portion of the document to be evaluated having the highest contrast can be extracted.

It is also preferable to use, as the design impression information, the physical feature amounts themselves obtained from document data. For example, a combination of the average colors of the background region, the main region, and the accent region of document data may be used by itself as a color palette, which serves as the design impression information.

Once the design impression is selected, the design impression evaluation process is terminated. The control section 10 then returns the control to step S0. While in the present exemplary embodiment a document is divided into plural sections for processing, the processing may be performed with regard to a single document as a whole.

### 2-3. User Impression Acquisition Process

When a user impression acquisition button 24 is clicked in step S0, the processing proceeds to the user impression acquisition process in step S30.

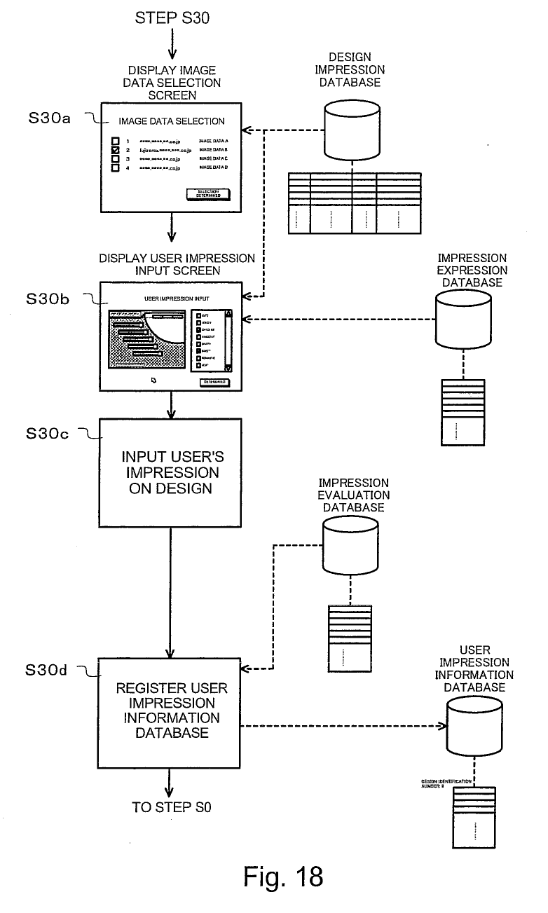

In the user impression acquisition process in step S30, an impression a user has of the document data captured in step S20 (hereinafter referred to as user impression information) is acquired. This process is performed in accordance with the flowchart shown in FIG. 18.

First, in step S30a, the control section 10 causes the output section 16 to display a document data selection screen 1006 for urging selection of document data for which an impression is to be acquired from the document data captured in step S20.

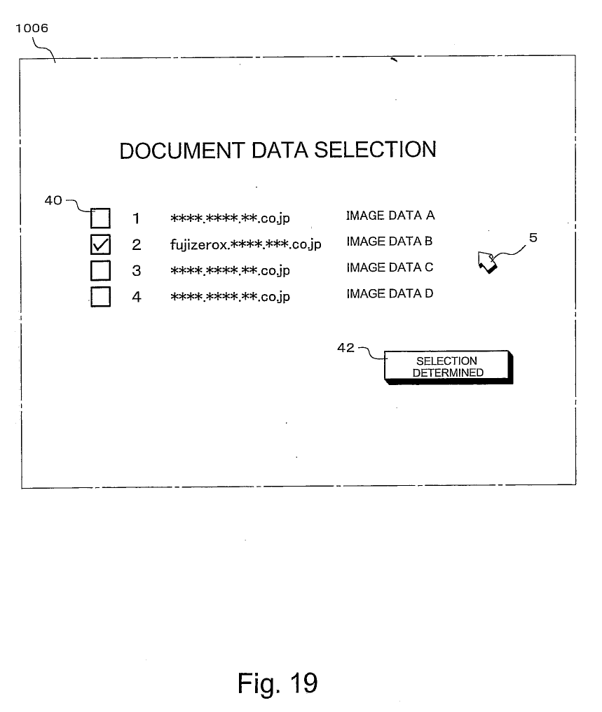

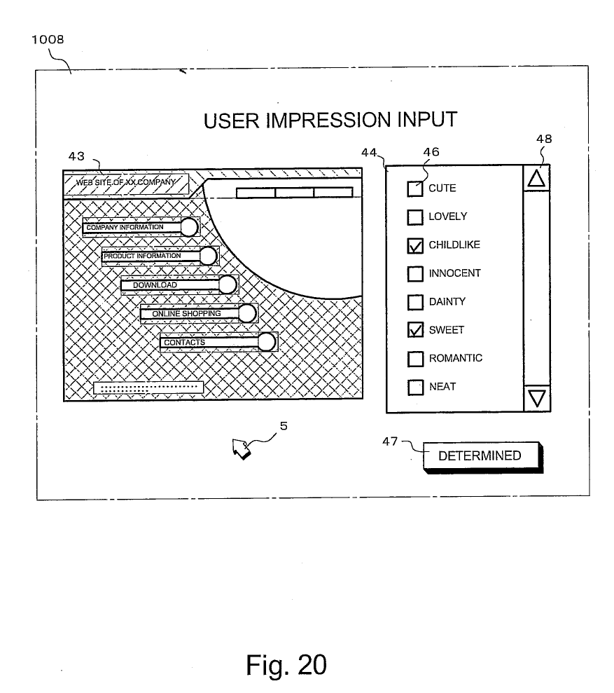

As shown in FIG. 19 the document data selection screen 1006 preferably displays a list of information concerning the document data held in the design database of the storage section 12 so as to allow selection of document data for which user impression information is to be acquired. However, the structure of the document data selection screen 1006 is not limited to this example, and any structure may be adopted as long as it allows selection of document data stored in the design database.

The user who will input an impression on document data moves the mouse pointer 5 to a check box 40 provided for each item of information concerning document data (image data) on the document data selection screen 1006 by means of the input section 14 such as a mouse, and clicks the check box 40 for selecting information. The user then moves the mouse pointer 5 to a selection determination button 42 and clicks the button 42 using a mouse, thereby determining selection of document data.

In step S30b, the control section 10 causes the output section 16 to display a user impression input screen 1008 for urging the user to input a user's impression when they see the document data.

The user impression input screen 1008 is divided into a region 43 which displays the content of the selected document data and a region 44 which displays information for expressing design impressions in the form of a list.

The control section 10 reads the document data selected in step S30a from the design database stored in the storage section 12, and forms an image of the document data and displays the image in the document data display region 43. When document data of a web page is selected, for example, the control section 10 reads the URL of the document data from the design database, and captures the document data from the URL and displays the data on the display.

The control section 10 further reads information for expressing a design impression from the impression expression database stored in the storage section 12, and displays the information on the impression expression display region 44. Here, similar to the desired impression determination process in step S10, it is preferable for the information for expressing an impression included in the impression expression database to be appropriately selected and used in accordance with the type of document data from among plural adjectives that express design impressions, color information including color palettes formed of a combination of colors, abstract images that abstractly express design impressions, and so on.

In this exemplary embodiment, the character information formed of plural adjectives is read from the impression information database shown in FIG. 7 and is displayed in the impression expression display region 44.

Subsequently, in step S30c, the user selects information matching an impression they feel at the sight of a design of the document displayed on the document data display region 43, using the input section 14.

For example, the mouse pointer 5 is previously displayed in the impression expression display region 44 where adjectives are listed, and the user, using a mouse, moves the mouse pointer 5 to a check box 46 provided for an adjective matching the impression given by the design and clicks the check box 46 with the mouse, thereby selecting the information. A check mark is displayed in the selected check box 46. At this time, by moving the mouse pointer 5 on scroll buttons 48 and clicking with the mouse, display of adjectives can be changed as necessary. When selection of adjectives is completed, the user moves the mouse pointer 5 to the position of a determination button 47 and clicks the button 47, thereby storing the character information of the selected adjectives in the storage section 12. For example, the character information of “childlike”, “sweet”, and “fresh” is stored in the storage section 12.

The method for acquiring the user impression is not limited to this example, and may be any method as long as it can facilitate user's input of an impression on the document data.

In step S30d, the user impression information is fixed based on the information selected in step S30c. For the determination of the user impression information, the impression evaluation database used in the desired impression determination process in step S10 is used.

Specifically, the control section 10 reads the information (adjectives) selected in step S30c from the storage section 12 and refers to the impression evaluation database shown in FIG. 9 to extract the impression information associated with the information (adjectives) that is read, and the corresponding weighting factors. The control section 10 then stores the extracted impression information and the evaluation value, which is a sum of the weighting factors for the respective impression information, in association with the design identification number in the storage section 12 in the form of a user impression information database.

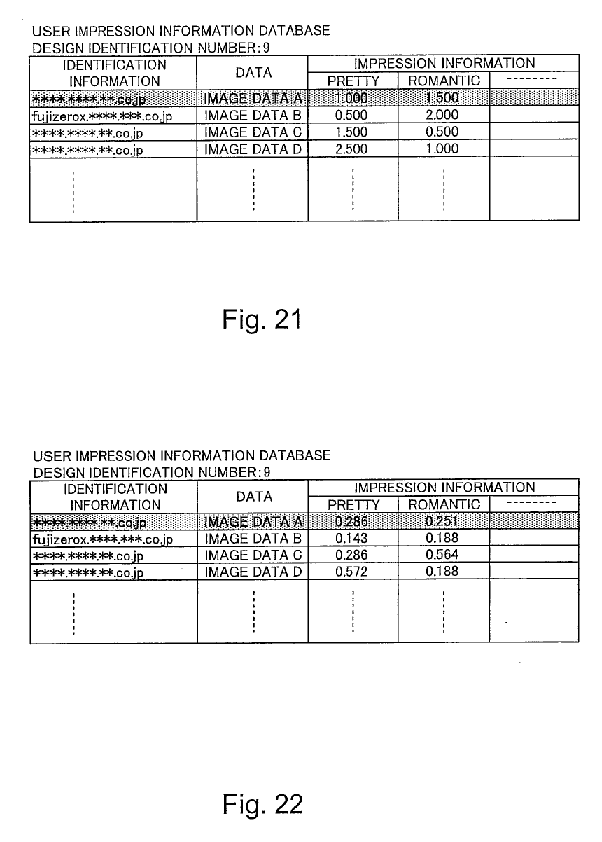

For example, when the selected character information is “childlike”, in the example of the impression evaluation database shown in FIG. 9, the impression information “pretty” is extracted, and the weighting factor of “childlike” with respect to “pretty”, which is 1.000, is extracted. Further, when “sweet” is selected, the impression information “romantic” is extracted, and its weighting factor with respect to “romantic”, which is 1.000, is extracted. Further, when “fresh” is selected, the impression information “romantic” is extracted, and its weighting factor with respect to “romantic”, which is 0.500, is extracted. In this case, as the evaluation value for each impression information, the evaluation value for “pretty” is 1.000, and the evaluation value for “romantic” is 1.500. Consequently, the user impression information database as shown in FIG. 21 is registered.

While in the above example the user impression information database is registered based on information selection by a single client, it is also preferable to repeat the above processing to thereby register the user impression information database based on the information obtained from plural clients. For example, when a web page for introducing a company is created, plural viewers are caused to select adjectives representing the impression given by the actual document design, and the control section 10 then extracts the impression information and calculates the evaluation value, which is a sum of the weighing factors for each extracted impression information. The control section 10 further summates the evaluation values for each impression information from the plural viewers and obtains the sum for each impression information, thereby registering the user impression information database.

Further, it is also preferable to repeat the above processing concerning a single user, or users having the same attribute, at certain intervals, to thereby register the user impression information database in consideration of changes with time in the viewer's impression of the actual document design.

In this case, each and every time the single user or the users having the same attribute perform the above processing at a certain interval, the evaluation value which is a sum of weighting factors is calculated for each extracted impression information. Then, the evaluation values thus calculated are summated for each impression information, and the sum is associated with each impression information, thereby registering the user impression information database.

According to the present exemplary embodiment, because the weighting factor associated with each information is set based on the degree of significance of each information with respect to the corresponding impression information, the resulting user impression information can clearly indicate the tendency of the document design impression, as in the desired impression determination process described above.

The processing for the user impression determination process is not limited to the above example. For example, when the object of design includes plural colors, such as a presentation material, a web page, an appearance of a new product, brand logo of a company, and so on, it is also possible to register color palettes formed by a combination of plural colors and plural abstract images which give different impressions to humans in the form of the impression expression database and display a list of them on the user impression input screen to allow the client to select the color pallet or the like, thereby further allowing the client to select the impression information associated with the selected color palette.

### <Modification Example>

In the above exemplary embodiment, the weighting factor which is set based on the degree of significance of each information with respect to the corresponding impression information is used for processing. In this modification example, the weighting factor is set such that each impression information is equally evaluated, thereby performing processing.

Specifically, in step S30d, the impression evaluation database representing a user impression given by the actual document design is registered based on the information selected in step S30c. In this example, however, the impression evaluation database shown in FIG. 11 is used for the processing.

The control section 10 reads the information (adjectives) selected in step S30c from the storage section 12, and extracts the impression information and the corresponding weighting factors associated with the information (adjectives) thus read by referring to the impression evaluation database shown in FIG. 11. The control section 10 further summates the weighting factors for each impression information which is selected. The control section 10 then stores in the storage section 12 the extracted impression information and an evaluation value which is a sum of the weighting factors for each impression information in the form of a user impression information database in association with the identification number of a design.

For example, if the character information which is selected is “childlike”, the impression information “pretty” is extracted in the example impression evaluation database of FIG. 11, and the weighting factor 0.286 of “childlike” with respect to “pretty” is extracted. Further, if the character information “sweet” is selected, the impression information “romantic” is extracted, and the weighting factor thereof with respect to “romantic”, which is 0.188, is extracted. In addition, if the character information “fresh” is selected, the impression information “romantic” is extracted, and the weighting factor thereof with respect to “romantic”, which is 0.063, is extracted. In this case, as the evaluation value for each impression information, the evaluation value for “pretty” is 0.286, and the evaluation value for “romantic” is 0.251. Consequently, the user impression information database as shown in FIG. 22 is registered.

Here, as described in the above exemplary embodiment, it is also preferable to repeat the above processing to calculate the evaluation value of each impression information from information obtained from plural clients. It is further preferable to repeat the above processing at certain intervals concerning a single user or users having the same attribute, to thereby calculate the evaluation value of each impression information in consideration of changes with time in the user's impression of the actual document design.

This modification example, in which the weighting factor associated with each information is set such that each impression information is equally evaluated, is suitable for a case where an impression desired for design creation is compared among different impression information or is compared with the evaluation results of other impressions.

Further, it is also possible to store both the impression evaluation databases shown in FIGS. 9 and 11 in the storage section 12 and select either one of these databases as required for reference. For example, it is preferable to cause a user to select either one of these impression evaluation databases for reference in step S30d, and perform processing with reference to the database selected by the user. This allows the user to select whether the user wishes to register a user impression information database which clearly indicates the tendency of an impression given by the actual design or a user impression information database which allows clear comparison with other impression information.

### 2-4. Impression Presentation and Correction Process

When an impression presentation and correction process button 26 is clicked in step S0, the processing proceeds to the impression presentation and correction process in step S40.

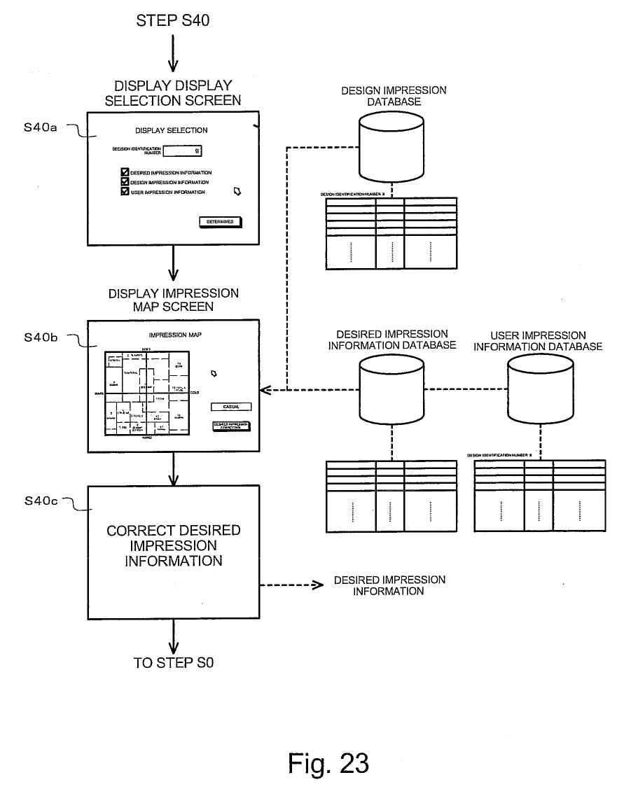

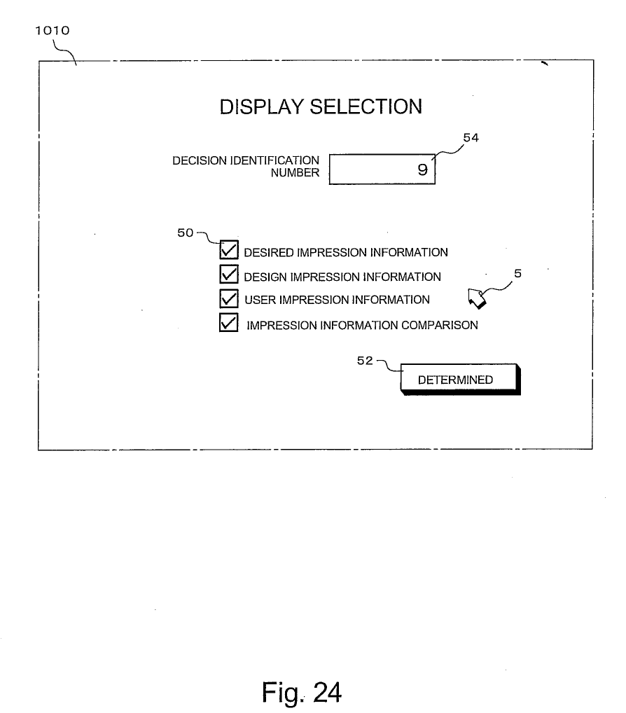

The impression presentation and correction process in step S40 is performed in accordance with the flowchart shown in FIG. 23, for presenting information concerning a document design based on the desired impression information database obtained in step S10, the design impression information obtained in step S20, and the user impression information database obtained in step S30.

First, in step S40a, the control section 10 causes the output section 16 to display a display selection screen 1010 for allowing the operator to select which information is to be displayed.

Specifically, on the display selection screen 1010, the operator inputs the identification number of a design to be displayed in an input box 54. The operator further selects among check boxes 50 and clicks a determination button 52, thereby selecting information to be displayed among the desired impression information, the design impression information, the user impression information, and impression information comparison. Here, the impression information comparison refers to information indicating a difference between the desired impression information and the user impression information, and therefore refers to processing for displaying information indicating a difference between an impression that is desired for design creation of a document and a user's impression of an actual document.

Then, in step S40b, the control section 10, receiving input of information to be displayed, displays at least one of the desired impression information, the design impression information, the user impression information, and the impression information comparison on an impression map screen 1012.

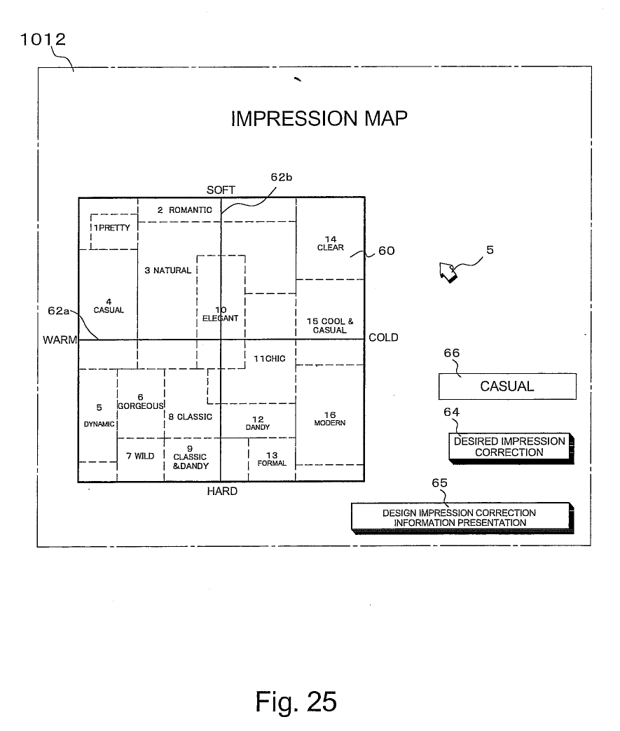

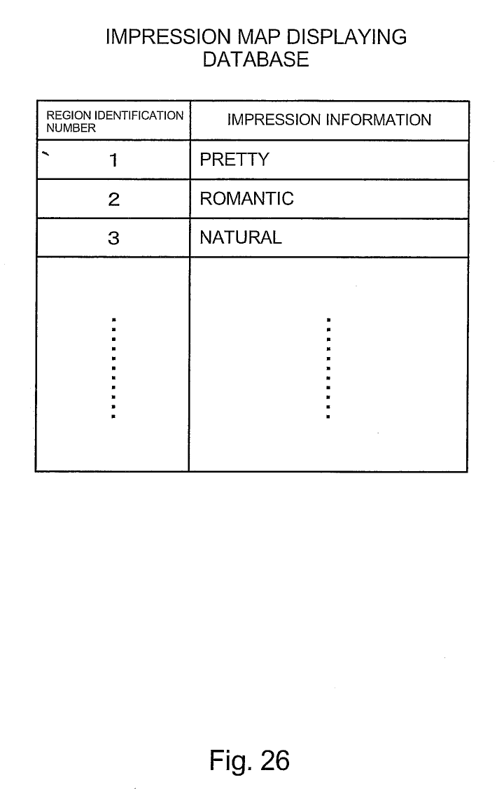

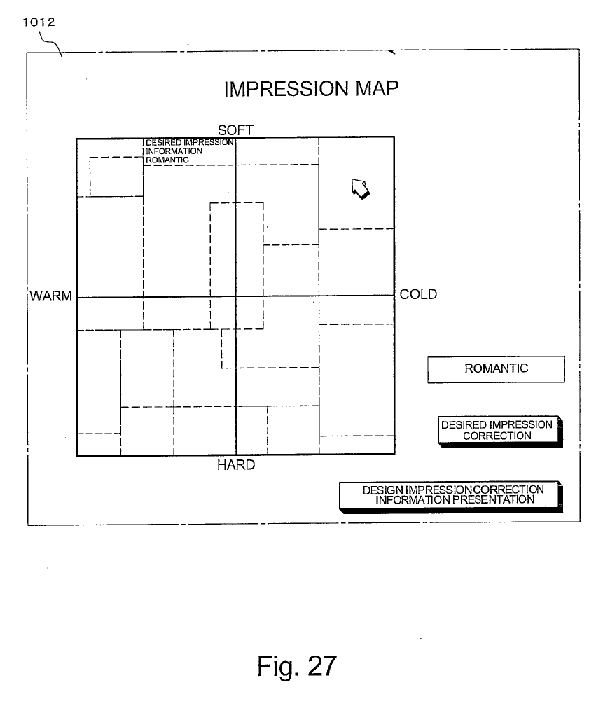

As shown in FIG. 25, the impression map screen 1012 is divided into plural regions each of which is designated by a region identification number. On the other hand, the storage section 12 stores information which expresses an impression in association with each region identification number in the form of the impression map displaying database, as shown in FIG. 26.

Here, it is preferable to provide coordinates axes on the impression map screen 1012 and assign the region identification number such that the impression changes with a predetermined tendency along the coordinate axes. In the example of the impression map screen 1012 shown in FIG. 25, for example, two orthogonal coordinate systems, that are X coordinates representing the warmth of a design between “warm” and “cool and Y coordinates representing the hardness of a design between “soft” and “hard”, are provided, and information representing an impression is allocated along the respective coordinate axes in accordance with the change of impression. However, the method of allocating information on the impression map screen 1012 is not limited to this example, and it is preferable to change the setting of the coordinate axes in accordance with the type of an object design.

When the desired impression information is selected in step S40a, the control section 10 refers to the desired impression information database to extract, as the desired impression information, the impression information that is stored with the highest value. Consequently, the desired impression information associated with the design identification number is superposed on the impression map screen 1012 for display.

More specifically, at this time, the control section 10 refers to the impression map displaying database to extract the region identification number corresponding to the desired impression information. The control section 10 then displays the desired impression information in a region on the impression map screen 1012 to which the extracted region identification number is assigned.

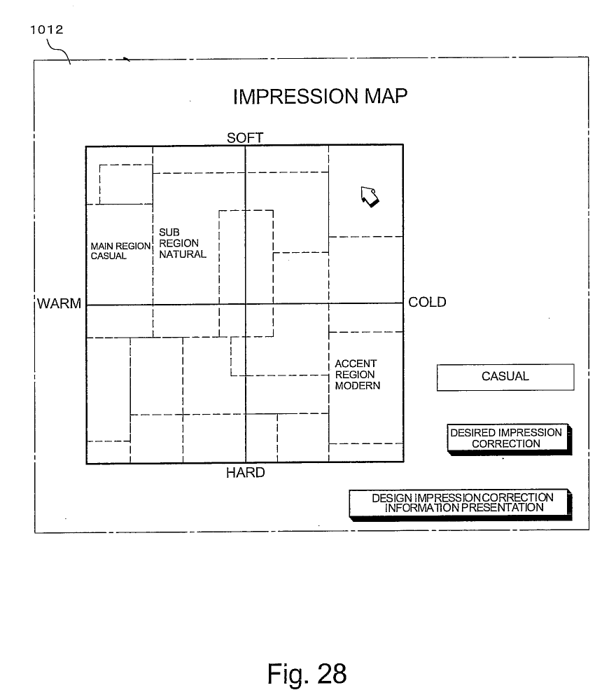

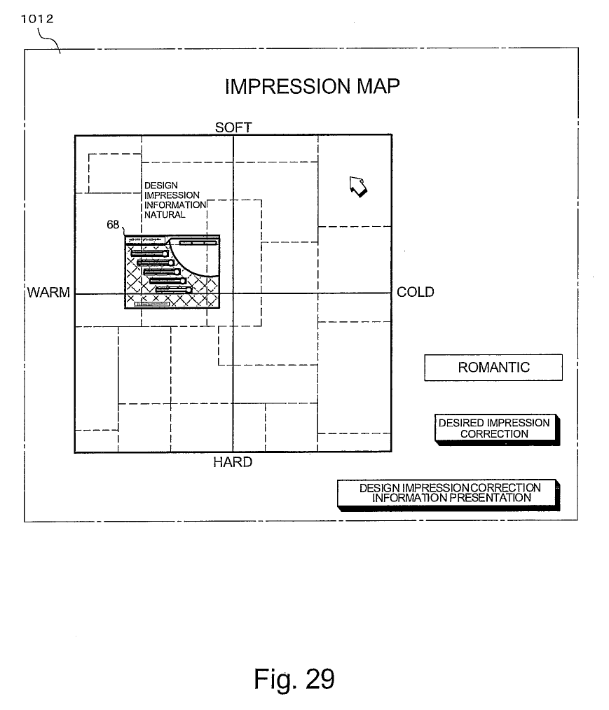

Here, it is possible to refer to the desired impression information database to extract the impression information with the highest value, the impression information with the second highest value, and the impression information with the third highest value as desired impressions of designs for the main region, the sub region, and the accent region of a document, respectively. In this case, it is preferable to display each extracted impression information such that they are superposed on the impression map screen 1012, as shown in FIG. 28.

When the desired impression information is set using the impression evaluation database shown in FIG. 9, the desired impression information displayed on the impression map screen 1012 clearly indicates a tendency of an impression desired for design creation. On the other hand, when the desired impression information is set using the impression evaluation database shown in FIG. 11, the desired impression information displayed on the impression map screen 1012 can be compared objectively and precisely with the design impression information and the user impression information.

When the design impression information is selected in step S40a, the design impression information associated with the design identification number which is included in the design database is displayed such that it is superposed on the impression map screen 1012. At this time, it is preferable to facilitate discrimination among displayed information, such as by using different colors for displaying information for each document data contained in the design database, and so on. It is also preferable that, in place of and/or in addition to each design impression information, the corresponding document data itself is displayed.

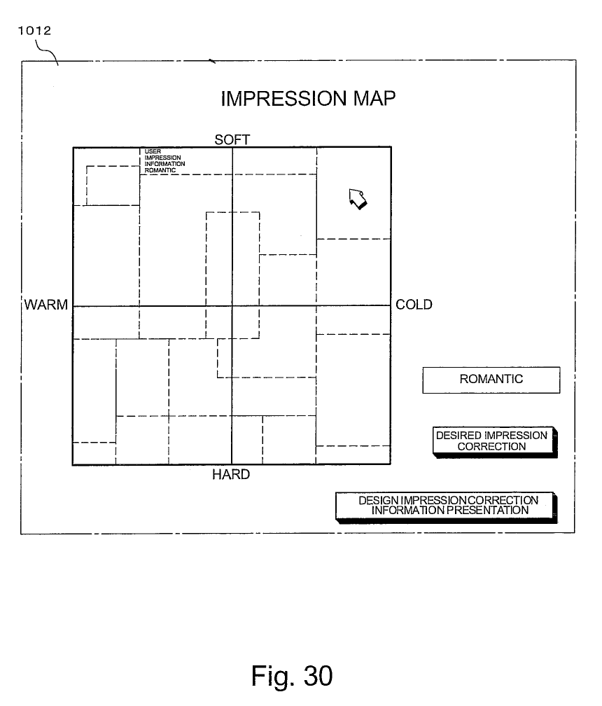

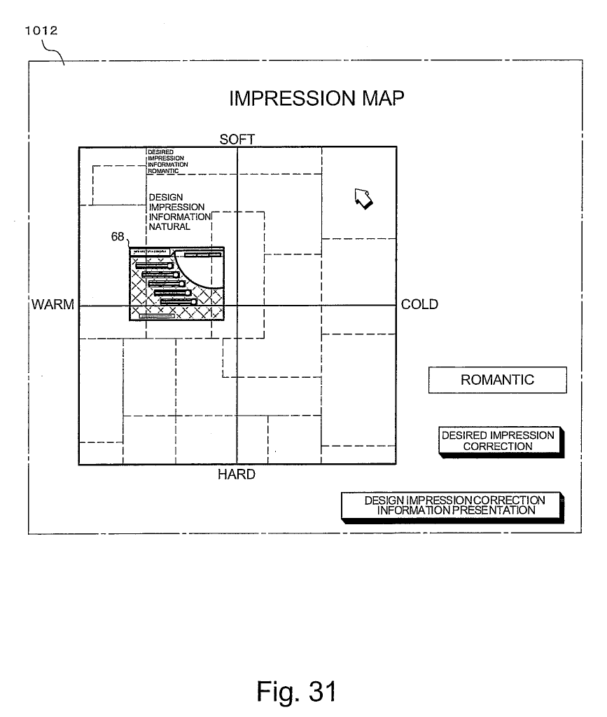

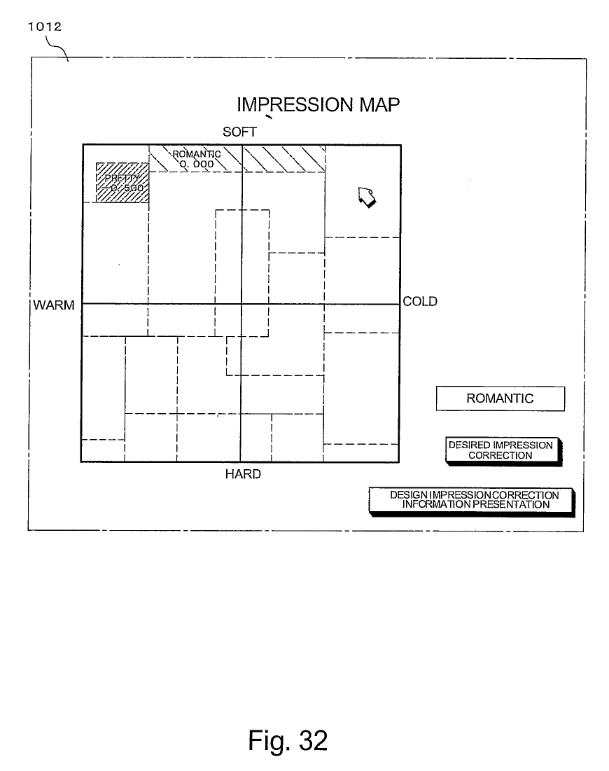

When the user impression information is selected in step S40a, the control section 10 refers to the user impression information database to extract, as the user impression information, the impression information that is stored with the highest value. Consequently, the user impression information associated with the design identification number which is included in the user impression information database is superposed on the impression map screen 1012 for display, as shown in FIG. 30. At this time, it is preferable to facilitate discrimination among displayed information, such as by using different colors for displaying information for each document data contained in the user impression information database, and so on.

When the user impression information is set using the impression evaluation database shown in FIG. 9, the user impression information displayed on the impression map screen 1012 clearly indicates a tendency of an impression desired for design creation. On the other hand, when the user impression information is set using the impression evaluation database shown in FIG. 11, the user impression information displayed on the impression map screen 1012 can be compared objectively and precisely with the desired impression information and the design impression information.

Further, when both the desired impression information and the design impression information is selected in step S40a, both the desired impression information and the design impression information associated with the design identification number is superposed on the impression map screen 1012 for display. Similarly, in cases where both the desired impression information and the user impression information is selected, where the design impression information and the user impression information is selected, and where all the desired impression information, the design impression information and the user impression information is selected, each item of information is superposed on the impression map screen 1012 for display.

By displaying the desired impression information, the design impression information, and the user impression information on the single impression map screen 1012 in a superposed manner as described above, it is possible for a design creator, a client, and a user to confirm the information while visually comparing the impression desired for the design creation, the impression of the actual design, and the user's impression of the actual design. At this time, because each information is displayed on the impression map 1012 along the coordinate axis indicating the impression tendency, the degree of difference among the desired impression, the impression of the actual design, and the user's impression, the tendency of impression, and so on can be clearly recognized.

Further, by previously obtaining the design impression information with regard to designs of other companies' web pages and other products in step S20, the desired impression information can also be compared with these information items for confirmation. This can facilitate recognition of correspondence or difference of the desired impression of a design to be created with respect to other companies' web pages and other products.

In addition, by previously obtaining the user impression information on the same design from plural users in step S30, the distribution tendency of the user impression information can be easily confirmed on the impression map screen 1012. At the same time, correspondence or difference in the distribution tendencies between the desired impression information or the design impression information and the user impression information can be readily recognized.

Further, it is possible to previously associate an abstract picture with each region on the impression map screen 1012 and display the corresponding abstract picture, as the desired impression information, the design impression information, and the user impression information, on the regions corresponding to the desired impression information, the design impression information, and the user impression information, respectively, in place of or in addition to the associated adjectives. The same structure is similarly applicable to the case where color palettes are used.

When the impression information comparison is selected in step S40a, the control section 10, referring to the desired impression information database and the user impression information database, displays information indicating a difference between the impression desired for design creation and the user's impression given by the design of an actual document on the impression map.

Specifically, the control section 10 calculates, for each impression information, a difference value by subtracting from an integration value associated with impression information registered in the desired impression information database an integration value registered in the user impression information database associated with the same impression information. For example, when, with regard to the impression information “pretty”, the integration value of 0.500 is registered in the desired impression information database and the integration value of 1.000 is registered in the user impression information database, the difference value with regard to the impression information “pretty” is −0.500. With regard to other impression information whose integration values registered in the desired impression information database or the user impression information are other than 0, a difference value is calculated in the same manner.

Once the difference value is calculated, the control section 10 displays the calculated difference value in a region on the impression map screen 1012 where the corresponding impression information is allocated in a superposed manner.

At this time, it is preferable to facilitate discrimination of the displayed difference values by using different colors for displaying information depending on whether the difference value is positive or negative or the absolute value of the difference value, and so on. For example, when the difference value is a positive value, i.e. when the actual impression is weaker than the desired impression, the region on the impression map screen 1012 where the corresponding impression information is allocated is painted with a bluish color and the difference value is displayed on the colored region. When the difference value is a negative value, i.e. when the actual impression is stronger than the desired impression, on the other hand, the region on the impression map screen 1012 where the corresponding impression information is allocated is painted with a reddish color and the difference value is displayed on the colored region. In addition, these bluish and reddish colors may be further gradated in accordance with the absolute value of the difference value.

By presenting the difference between the impression which is determined as a desired impression for design creation and the user's impression given by the design of the document actually created as described above, it is possible to visually recognize the difference between the impression of the actual design and the desired design in an easy manner. In particular, by presenting a value indicating the difference in impression for each impression information corresponding to each divided region on the impression map, it is possible to readily recognize which impression is weaker or stronger than the desired impression, and so on.

Alternatively, the control section 10 may display, for each impression information, one of the integration value registered in the desired impression information database in association with the impression information, and the integration value registered in the user impression information database in association with the impression information, which is lower than the other integration value. For example, when, with regard to the impression information “pretty”, the integration value of 0.500 is registered in the desired impression information database and the integration value of 1.000 is registered in the user impression information database, the integration value of 0.500 registered in the desired impression information database is the lower value with regard to the impression information “pretty”. With regard to other impression information whose integration values registered in the desired impression information database or the user impression information are other than 0, the lower difference value is extracted in the same manner.

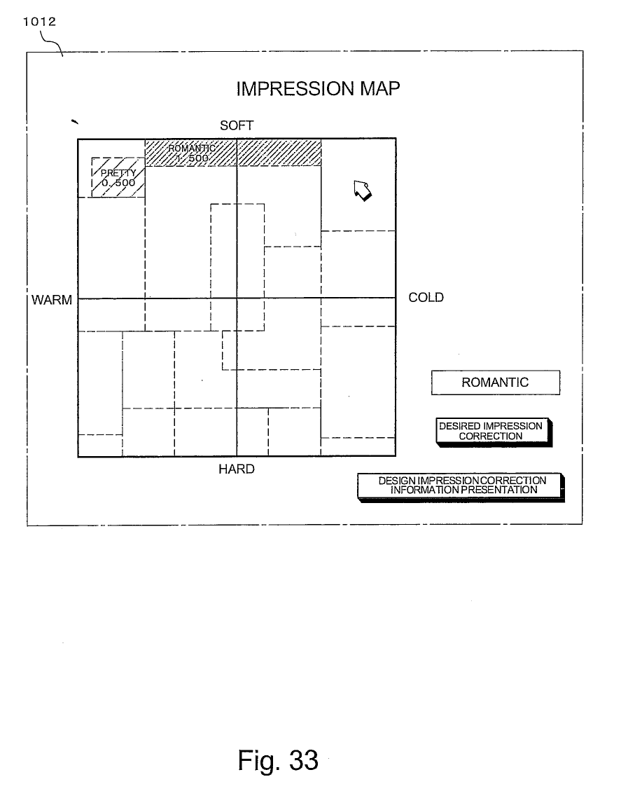

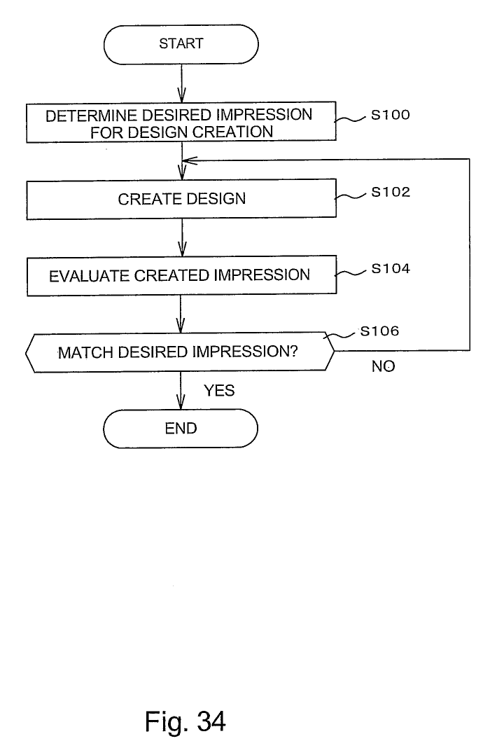

The control section 10 then displays the extracted result in the region on the impression map screen 1012 where the corresponding impression information is allocated in a superposed manner, as shown in FIG. 33.

At this time, it is preferable to change the color for displaying information or the like depending on which of the desired impression information database and the user impression information database the lower integration value is registered in. For example, when the actual impression has a lower value than the desired impression, the region on the impression map screen 1012 where the corresponding impression information is allocated is painted with a bluish color and the extracted value is displayed on the colored region. When the actual impression has a higher value than the desired impression, on the other hand, the region on the impression map screen 1012 where the corresponding impression information is allocated is painted with a reddish color and the extracted value is displayed on the colored region.

This facilitates visual recognition of the user concerning which of the impression determined as a desired impression for design creation, and the user's impression of the design of an actually created document, presents a stronger impression.

Here, the information representing the difference between the desired impression for design creation and the user's impression of the actual document can be displayed on the impression map based on the desired impression information database shown in FIG. 12 obtained in the modification example of the desired impression determination process and the user impression information database shown in FIG. 22 obtained in the modification example of the user impression acquisition process.

As a matter of course, the comparison result of the impression information may be displayed on the impression map such that it is superposed on at least one of the desired impression information, the design impression information, and the user impression information.

Further, according to the present exemplary embodiment, it is possible to present information that is useful for correcting the desired impression information or the design impression. Specifically, by moving the mouse pointer 5 to a desired impression correction button 64 or a design impression correction button 65 and clicking the button, the processing proceeds to step S40c.

When correction of the desired impression information is instructed, the control section 10 starts a process for setting the desired impression information.

The operator moves the mouse pointer 5 to a desired region on the impression map screen 1012 while referring to the design impression information and the user impression information displayed on the impression map screen 1012 and clicks on the region. The control section 10 acquires the position of the mouse pointer 5 and, referring to the impression expression database, sets the information expressing an impression that is allocated to that region as new desired impression information. Here, in order to facilitate confirmation of the new desired impression information which is set, it is preferable to provide a region 66 for displaying the desired impression information to thereby display the desired impression information.

With the use of the desired impression information setting method described above, by previously displaying a web design of a competing company as the design impression information on the impression map screen 1012 in a superposed manner, for example, the following advantages can be achieved. Specifically, when a user wishes to have a desired impression of the web design of their company that is different from the impression of the web design of the competitor company, appropriate desired impression information can be easily set by designating a region which does not overlap with the region where the design impression information of the competitive company's web design is displayed. On the contrary, when the user wishes to obtain a web design whose impression is similar to the impression of the web design of the competing company, appropriate desired impression information can be set by designating the region where the design impression information of the competing company's web design is displayed. Similarly, by displaying the user impression information on the impression map screen 1012 in a superposed manner, it is possible to newly set the desired impression information with reference to the user's impression.

Further, by moving the mouse pointer 5 to the design impression correction information presentation button 65 provided on the impression map screen 1012 and clicking on the button, the information required by the operator to correct the design impression information can be presented. For example, it is preferable to register a combination of colors of the background region, the main region, and the accent region of a design suitable for an impression allocated to each region of the impression map screen 1012 in the form of database and display the combination of colors corresponding to the region where the desired impression information is displayed on the impression map screen 1012 in a superposed manner. By changing the design to the combination of colors which is displayed, a design closer to the desired impression can be obtained.

By presenting the information for supporting correction of the desired impression information and correction of design on the same impression map screen 1012, an operation can be performed while visually confirming the desired impression, the impression of the actual design, and the impression given to a user.

As such, according to the present exemplary embodiment, the correspondence and difference among the impression desired for design creation, the impression of the actual design, and the user's impression of the actual design can be confirmed on the same impression map screen.

In this manner, it is possible for a client and a design creator to visually recognize the suitability of setting of the desired impression for design creation, leading to easy correction of the desired impression and design impression. Further, the above structure of the present exemplary embodiment facilitates tuning of information between the client and the design creator during the operation for design creation, so that the operation can be performed smoothly.

Further, it is easy to detect the direction of design correction based on the impression desired by the client and the user's impression of the created design.

While in the above exemplary embodiment a visual design such as a design of a web page, presentation materials, products, and so on, has been described, similar advantages to those of the present invention can be achieved with respect to audio data such as commercial speech or the like, by acquiring the desired impression information, the design impression information and the user impression information and displaying the information on the same impression map screen.

The foregoing description of the exemplary embodiment of the present invention has been provided for the purposes of the illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical application, thereby enabling others skilled in the art to understand the invention for various embodiments and with the various modifications as are suited to the particular use contemplated. It is intended that the scope of the invention be defined by the following claims and their equivalents.

What is claimed is:

1. A computer readable recording medium storing a design creation supporting program causing a computer having a memory that stores an impression expression database including options that express an impression of a document and an impression evaluation database storing impression information that represents an impression of a human at the sight of a document in association with the options included in the impression expression database, to execute a process for supporting design creation, the process comprising:
causing a user to select and acquire at least one option that matches an impression that is desired for design creation of a document from the impression expression database;
causing a user to select and acquire at least one option that matches an impression given by a design of an actual document from the impression expression database;
extracting impression information associated with the option selected in the process for causing a user to select and acquire at least one option that matches an impression that is desired for design creation of a document, with reference to the impression evaluation database, and storing an evaluation value obtained with respect to the impression information that is extracted in association with the extracted impression information in the form of a desired impression information database; and
extracting impression information associated with the option selected in the process for causing a user to select and acquire at least one option that matches an impression given by a design of an actual document, with reference to the impression evaluation database, and storing an evaluation value obtained with respect to the impression information that is extracted in association with the extracted impression information in the form of a user impression information database.

2. The recording medium according to claim 1, wherein
when the impression evaluation database stores the impression information that represents an impression of a human at the sight of a document in association with the options included in the impression expression database, and a weighting factor indicating a degree of significance of each of the options associated with each impression information,
the extracting of impression information associated with the option selected in the process for causing a user to select and acquire at least one option that matches an impression that is desired for design creation of a document and storing an evaluation value comprises:
extracting impression information associated with the options selected in the process for causing a user to select and acquire at least one option that matches an impression that is desired for design creation of a document from the impression expression database, with reference to the impression evaluation database;
calculating, for each impression information that is extracted, an evaluation value that is a sum of the weighting factors associated with the options selected from the impression information database; and
storing the evaluation value in association with each impression information that is extracted in the form of a desired impression information database, and
the extracting of impression information associated with the option selected in the process for causing a user to select and acquire at least one option that matches an impression given by a design of an actual document and storing an evaluation value comprises:
extracting impression information associated with the options selected in the process for causing a user to select and acquire at least one option that matches an impression given by a design of an actual document from the impression expression database, with reference to the impression evaluation database;
calculating, for each impression information that is extracted, an evaluation value that is a sum of the weighting factors associated with the options selected from the impression information database; and
storing the evaluation value in association with each impression information that is extracted in the form of a user impression information database,
and wherein
the recording medium stores a design creation supporting program causing the computer to execute a process, the process comprising: presenting information that represents a differences between the evaluation value registered in the desired impression information database and the evaluation value registered in the user impression information database for each impression information.

3. The recording medium according to claim 1, wherein
when the impression evaluation database stores the impression information that represents an impression of a human at the sight of a document in association with the options included in the impression expression database and a weighting factor of each option that is set such that a sum of weighting factors of the options associated with each impression information is equal to each other,
the extracting of impression information associated with the option selected in the process for causing a user to select and acquire at least one option that matches an impression that is desired for design creation of a document and storing an evaluation value comprises:
extracting impression information associated with the options selected in the process for causing a user to select and acquire at least one option that matches an impression that is desired for design creation of a document from the impression expression database, with reference to the impression evaluation database;
calculating, for each impression information that is extracted, an evaluation value that is a sum of the weighting factors associated with the options selected from the impression information database; and
storing the evaluation value in association with each impression information that is extracted in the form of a desired impression information database, and
the extracting of impression information associated with the option selected in the process for causing a user to select and acquire at least one option that matches an impression given by a design of an actual document and storing an evaluation value comprises:
extracting impression information associated with the options selected in the process for causing a user to select and acquire at least one option that matches an impression given by a design of an actual document from the impression expression database, with reference to the impression evaluation database;
calculating, for each impression information that is extracted, an evaluation value that is a sum of the weighting factors associated with the options selected from the impression information database; and
storing the evaluation value in association with each impression information that is extracted in the form of a user impression information database,
and wherein
the recording medium stores a design creation supporting program causing the computer to execute a process, the process comprising: presenting information that represents a difference between the evaluation value registered in the desired impression information database and the evaluation value registered in the user impression information database for each impression information.

4. The recording medium according to claim 2, wherein
the information that represents a difference between the evaluation values is a difference value between integration values for each impression information.

5. The recording medium according to claim 3, wherein
the information that represents a difference between the evaluation values is a difference value between integration values for each impression information.

6. The recording medium according to claim 2, wherein
the information that represents a difference between the evaluation values is one of integration values for each impression information that is smaller.

7. The recording medium according to claim 3, wherein
the information that represents a difference between the evaluation values is one of integration values for each impression information that is smaller.

8. The recording medium according to claim 2, wherein
the extracting of impression information associated with the option selected in the process for causing a user to select and acquire at least one option that matches an impression that is desired for design creation of a document and storing an evaluation value, or the extracting of impression information associated with the option selected in the process for causing a user to select and acquire at least one option that matches an impression given by a design of an actual document and storing an evaluation value, comprises calculating the evaluation value of the weighting factors based on the options selected from the impression information database by a plurality of users.

9. The recording medium according to claim 3, wherein
the extracting of impression information associated with the option selected in the process for causing a user to select and acquire at least one option that matches an impression that is desired for design creation of a document and storing an evaluation value, or the extracting of impression information associated with the option selected in the process for causing a user to select and acquire at least one option that matches an impression given by a design of an actual document and storing an evaluation value, comprises calculating the evaluation value of the weighting factors based on the options selected from the impression information database by a plurality of users.

10. The recording medium according to claim 2, wherein
the extracting of impression information associated with the option selected in the process for causing a user to select and acquire at least one option that matches an impression that is desired for design creation of a document and storing an evaluation value, or the extracting of impression information associated with the option selected in the process for causing a user to select and acquire at least one option that matches an impression given by a design of an actual document and storing an evaluation value, comprises calculating the evaluation value of the weighting factors based on the options selected from the impression information database by a single user or users having the same attribute at different times.

11. The recording medium according to claim 3, wherein
the extracting of impression information associated with the option selected in the process for causing a user to select and acquire at least one option that matches an impression that is desired for design creation of a document and storing an evaluation value, or the extracting of impression information associated with the option selected in the process for causing a user to select and acquire at least one option that matches an impression given by a design of an actual document and storing an evaluation value, comprises calculating the evaluation value of the weighting factors based on the options selected from the impression information database by a single user or users having the same attribute at different times.

12. The recording medium according to claim 2, wherein
the presenting of information comprises:
dividing an output screen into a plurality of divided screen regions;
allocating the impression information to each divided screen region; and
displaying the information that represents a difference between the integration values obtained for each impression information in the corresponding divided screen region.

13. The recording medium according to claim 3, wherein
the presenting of information comprises:
dividing an output screen into a plurality of divided screen regions;
allocating the impression information to each divided screen region; and
displaying the information that represents a difference between the integration values obtained for each impression information in the corresponding divided screen region.

14. A design creation supporting apparatus, comprising:
a memory that stores an impression expression database including options that express an impression of a document and an impression evaluation database storing impression information that represents an impression of a human at the sight of a document in association with the options included in the impression expression database; and
a controller that performs a process comprising:
causing a user to select and acquire at least one option that matches an impression that is desired for design creation of a document from the impression expression database;
causing a user to select and acquire at least one option that matches an impression given by a design of an actual document from the impression expression database;
extracting impression information associated with the option selected in the process for causing a user to select and acquire at least one option that matches an impression that is desired for design creation of a document with reference to the impression evaluation database; calculating an evaluation value with respect to the impression information that is extracted; and storing the evaluation value in association with each impression information that is extracted in the form of a desired impression information database; and
extracting impression information associated with the option selected in the process for causing a user to select and acquire at least one option that matches an impression given by a design of an actual document with reference to the impression evaluation database; calculating an evaluation value with respect to the impression information that is extracted; and storing the evaluation value in association with each impression information that is extracted in the form of a user impression information database.

15. A computer data signal embodied in a carrier wave for enabling a computer having a memory that stores an impression expression database including options that express an impression of a document and an impression evaluation database storing impression information that represents an impression of a human at the sight of a document in association with the options included in the impression expression database, to perform a process for supporting design creation, the process comprising:
causing a user to select and acquire at least one option that matches an impression that is desired for design creation of a document from the impression expression database;
causing a user to select and acquire at least one option that matches an impression given by a design of an actual document from the impression expression database;
extracting impression information associated with the option selected in the process for causing a user to select and acquire at least one option that matches an impression that is desired for design creation of a document with reference to the impression evaluation database, and storing an evaluation value obtained with respect to the impression information that is extracted in association with the extracted impression information in the form of a desired impression information database; and
extracting impression information associated with the option selected in the process for causing a user to select and acquire at least one option that matches an impression given by a design of an actual document with reference to the impression evaluation database, and storing an evaluation value obtained with respect to the impression information that is extracted in association with the extracted impression information in the form of a user impression information database.
